(19) United States
(12) Patent Application Publication
(10) Pub. No.: US 2018/0301926 A1
(43) Pub. Date: Oct. 18, 2018

(54) TUNABLE POWER SUPPLY DEVICE AND PARALLEL POWER SUPPLY SYSTEM

(71) Applicant: Wistron Corp., New Taipei City (TW)

(72) Inventors: Yu-Tzu ZHU, New Taipei City (TW); Te-Lung WU, New Taipei City (TW)

(21) Appl. No.: 15/629,932

(22) Filed: Jun. 22, 2017

(30) Foreign Application Priority Data
Apr. 18, 2017 (TW) 106112882

(51) Int. Cl. H02J 7/34; H02J 7/00

(52) U.S. Cl. CPC H02J 7/34; H02J 7/0065

(57) ABSTRACT

A tunable power supply device with an input node and an output node includes a voltage control module, a first diode, and a voltage divider circuit. The voltage control module converts an input voltage at the input node into a median voltage at a first node. The median voltage is determined according to a feedback voltage. The first diode has an anode coupled to the first node, and a cathode coupled to the output node for outputting an output voltage. The voltage divider circuit generates the feedback voltage according to the output voltage.

### CROSS REFERENCE TO RELATED APPLICATIONS

This Application claims priority of Taiwan Patent Application No. 106112882 filed on Apr. 18, 2017, the entirety of which is incorporated by reference herein.

### BACKGROUND OF THE INVENTION

### Field of the Invention

The disclosure generally relates to a tunable power supply device, and more particularly, to a tunable power supply device and a parallel power supply system for automatically calibrating an output voltage.

### Description of the Related Art

A conventional electronic device usually includes a single direct current (DC) battery used as an electric power source. Even if a user has two or more DC batteries, they cannot simultaneously supply electric power to the electronic device. Generally, DC batteries have a variety of output standards (e.g., different voltages), and therefore the DC batteries cannot provide electric power together when they are coupled in parallel.

In order to solve the above problem, there is a need to design a novel solution, so that one or more DC batteries with different standards can simultaneously provide electric power for the same electronic device.

### BRIEF SUMMARY OF THE INVENTION

In a preferred embodiment, the invention is directed to a tunable power supply device with an input node and an output node. The tunable power supply device includes a voltage control module, a first diode, and a voltage divider circuit. The voltage control module converts an input voltage at the input node into a median voltage at a first node. The median voltage is determined according to a feedback voltage. The first diode has an anode coupled to the first node, and a cathode coupled to the output node for outputting an output voltage. The voltage divider circuit generates the feedback voltage according to the output voltage.

In some embodiments, the voltage divider circuit includes a first resistor and a second resistor. The first resistor is coupled between the output node and a second node. The second resistor is coupled between the second node and a ground voltage. The second node is arranged for outputting the feedback voltage.

In some embodiments, the voltage control module controls the median voltage such that the output voltage is equal to a target system voltage. The resistances of the first resistor and the second resistor are determined according to the target system voltage.

In some embodiments, the voltage control module is a buck circuit.

In some embodiments, the buck circuit includes a comparator, a pulse width modulation (PWM) controller, a first buffer, a second buffer, a first N-type transistor, a second. N-type transistor, an inductor, and a capacitor. The comparator compares the feedback voltage with a reference voltage, so as to generate a comparison voltage. The PWM controller generates a first control signal and a second control signal. The pulse widths of the first control signal and the second control signal are adjusted according to the comparison voltage. The first buffer is configured to buffer the first control signal. The second buffer is configured to buffer the second control signal. The first N-type transistor has a control terminal for receiving the first control signal through the first buffer, a first terminal coupled to a third node, and a second terminal coupled to the input node. The second N-type transistor has a control terminal for receiving the second control signal through the second buffer, a first terminal coupled to a ground voltage, and a second terminal coupled to the third node. The inductor is coupled between the third node and the first node. The capacitor is coupled between the first node and the ground voltage.

In some embodiments, the voltage control module is a boost circuit.

In some embodiments, the boost circuit includes a comparator, a pulse width modulation (PWM) controller, an inductor, a first N-type transistor, a second diode, and a capacitor. The comparator compares the feedback voltage with a reference voltage, so as to generate a comparison voltage. The PWM controller generates a first control signal. The pulse width of the first control signal is adjusted according to the comparison voltage. The inductor is coupled between the input node and a third node. The first N-type transistor has a control terminal for receiving the first control signal, a first terminal coupled to a ground voltage, and a second terminal coupled to the third node. The second diode has an anode coupled to the third node, and a cathode coupled to the first node. The capacitor is coupled between the first node and the ground voltage.

In some embodiments, the voltage control module is a boost-buck circuit.

In some embodiments, the boost-buck circuit includes a comparator, a pulse width modulation (PWM) controller, a first buffer, a second buffer, a first N-type transistor, a second. N-type transistor, an inductor, a second diode, a third diode, and a capacitor. The comparator compares the feedback voltage with a reference voltage, so as to generate a comparison voltage. The PWM controller generates a first control signal and a second control signal. The pulse widths of the first control signal and the second control signal are adjusted according to the comparison voltage. The first buffer is configured to buffer the first control signal. The second buffer is configured to buffer the second control signal. The first N-type transistor has a control terminal for receiving the first control signal through the first buffer, a first terminal coupled to a third node, and a second terminal coupled to the input node. The second N-type transistor has a control terminal for receiving the second control signal through the second buffer, a first terminal coupled to a ground voltage, and a second terminal coupled to a fourth node. The inductor is coupled between the third node and the fourth node. The second diode has an anode coupled to the fourth node, and a cathode coupled to the first node. The third diode has an anode coupled to the ground voltage, and a cathode coupled to the third node. The capacitor is coupled between the first node and the ground voltage.

In another preferred embodiment, the invention is directed to a parallel power supply system including a plurality of tunable power supply devices, each as claimed above. The plurality of tunable power supply devices are coupled in parallel, so as to generate the same output voltage.

In some embodiments, the voltage control modules of the plurality of tunable power supply devices comprise a boost circuit, a buck circuit, a boost-buck circuit, or a combination thereof.

### BRIEF DESCRIPTION OF DRAWINGS

The invention can be more fully understood by reading the subsequent detailed description and examples with references made to the accompanying drawings, wherein:

FIG. 1 is a diagram of a tunable power supply device according to an embodiment of the invention;

FIG. 2 is a diagram of a tunable power supply device according to an embodiment of the invention;

FIG. 3 is a diagram of signal waveforms of a first control signal and a second control signal according to an embodiment of the invention;

FIG. 4 is a diagram of a tunable power supply device according to an embodiment of the invention;

FIG. 5 is a diagram of a tunable power supply device according to an embodiment of the invention,

FIG. 6A is a diagram of signal waveforms of a first control signal and a second control signal according to an embodiment of the invention;

FIG. 6B is a diagram of signal waveforms of a first control signal and a second control signal according to an embodiment of the invention; and

FIG. 7 is a diagram of a parallel power supply system according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

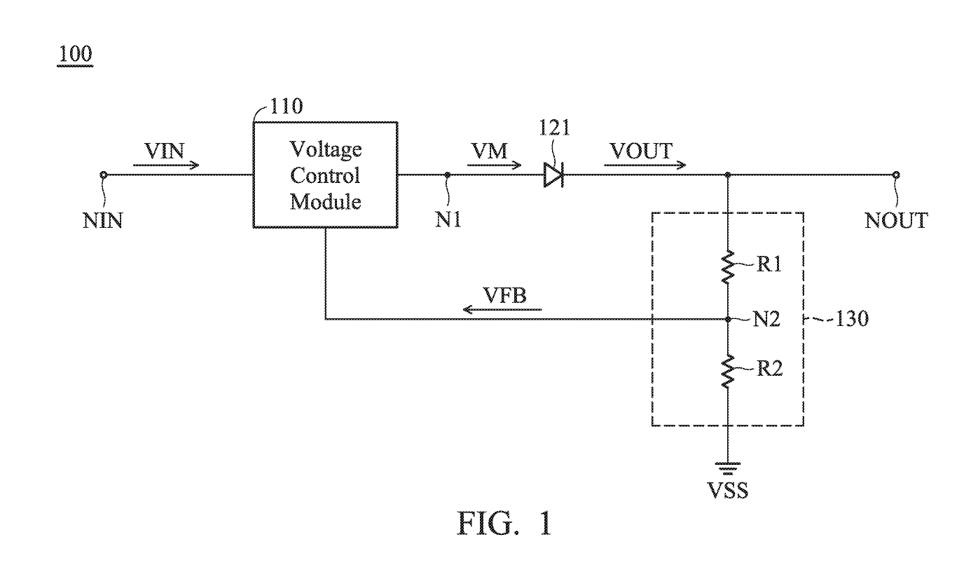

FIG. 1 is a diagram of a tunable power supply device 100 according to an embodiment of the invention. The tunable power supply device 100 may be applied to an electronic device or a mobile device, such as a smartphone, a tablet computer, or a notebook computer. As shown in FIG. 1, the tunable power supply device 100 includes a voltage control module 110, a first diode 121, and a voltage divider circuit 130. The tunable power supply device IOU has an input node NIN and an output node NOUT. The input node NIN is arranged for receiving an input voltage VIN, and the output node NOUT is arranged for outputting an output voltage VOUT. Generally, the input voltage VIN is any voltage, and it is processed by the tunable power supply device 100, such that the final output voltage VOUT is equal to a target system voltage. The target system voltage may be higher than, equal to, or lower than the original input voltage VIN. In some embodiments, the input voltage VIN comes from a direct current (DC) voltage source or a DC battery, and the output voltage VOUT is another DC voltage. Therefore, the tunable power supply device 100 is considered as a DC-to-DC converter, which automatically adjusts a variety of different input voltages VIN and provides an output voltage VOUT with an appropriate voltage level.

The voltage control module 110 can convert the input voltage VIN at the input node NIN into a median voltage VM at a first node N1. The median voltage VM is determined according to a feedback voltage VFB. For example, the median voltage VM may be higher than, equal to, or lower than the original input voltage VIN. The first diode 121 has an anode coupled to the first node N1 for receiving the median voltage VM, and a cathode coupled to the output node NOUT for generating the output voltage VOUT. The first diode 121 can block an output current flowing back from the output node NOUT, and effectively prevent the output voltage VOUT and the output current from directly interfering with the voltage control module 110. The voltage divider circuit 130 generates the feedback voltage VFB according to the output voltage VOUT. The feedback voltage VFB may be a predetermined percentage of the output voltage VOUT (e.g., 30% or 40% of the output voltage VOLT, but it is not limited thereto). In some embodiments, the voltage divider circuit 130 includes a first resistor R1 and a second resistor R2. The first resistor R1 is coupled between the output node NOUT and a second node N2. The second resistor R2 is coupled between the second node N2 and a ground voltage VSS. The second node N2 is arranged for outputting the feedback voltage VFB to the voltage control module 110. The feedback voltage VFB is calculated according to the following equation (I).

$$VFB = ( \frac{R 2}{R 1 + R 2} ) \cdot VOUT \qquad ( 1 )$$

where “VFB” represents the voltage level of the feedback voltage VFB, “R1” represents the resistance of the first resistor R1, “R2” represents the resistance of the second resistor R2, and “VOUT” represents the voltage level of the output voltage VOUT.

The voltage control module 110 can control the median voltage VM according to the feedback voltage VFB with a negative feedback mechanism, such that the final output voltage VOUT can be equal to the target system voltage. In some embodiments, the resistances of the first resistor R1 and the second resistor R2 are determined according to the aforementioned target system voltage.

With the proposed design of the invention, regardless of the voltage level of the original input voltage VIN, the tunable power supply device 100 can adjust it and output the same target system voltage. Accordingly, when there are a plurality of tunable power supply devices 100 for respectively receiving a plurality of different input voltages VIN, these tunable power supply devices 100 can be coupled in parallel with each other and simultaneously supply the same output voltage VOUT to an electronic device or a mobile device, thereby effectively enhancing the whole efficiency of power supply.

The following embodiments will introduce the detailed circuit structure and implement method of the tunable power supply device 100. It should be understood that these figures and embodiments are just exemplary, rather than limitations of the claim scope of the invention.

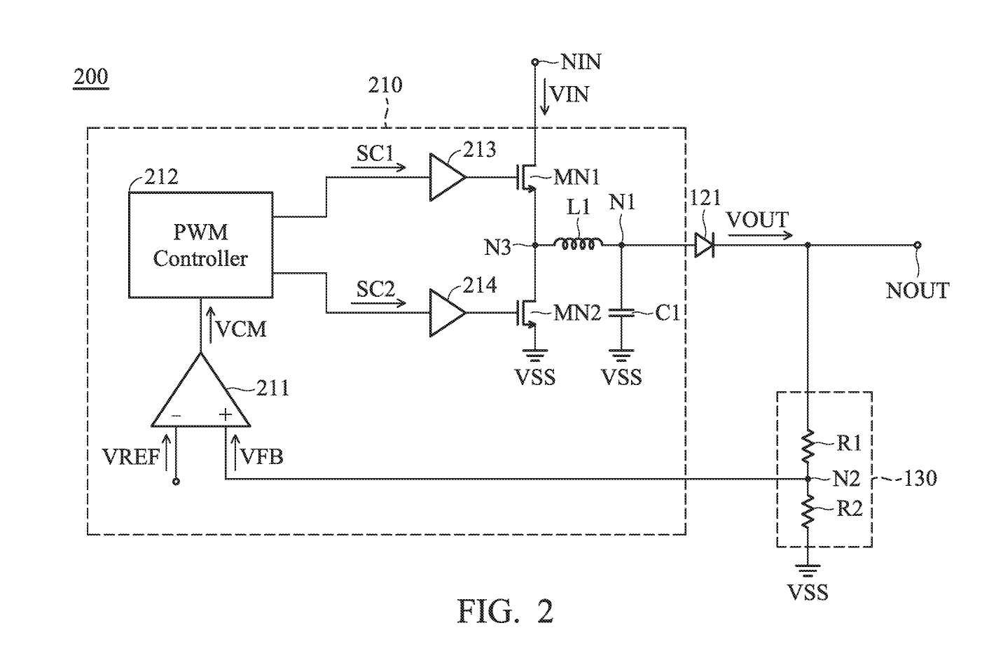

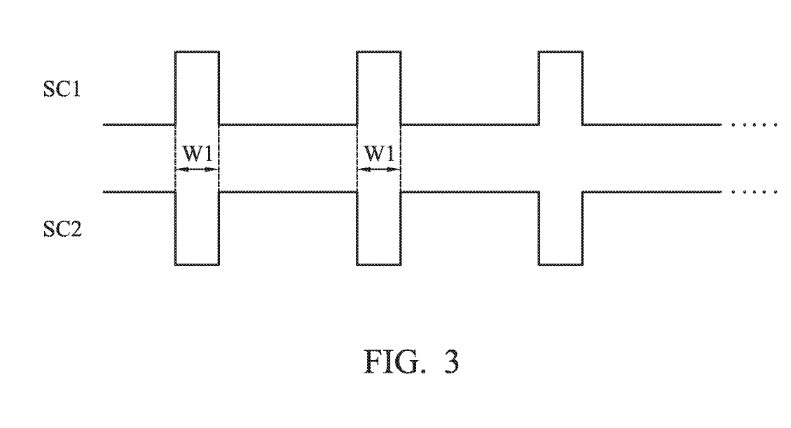

FIG. 2 is a diagram of a tunable power supply device 200 according to an embodiment of the invention. In the embodiment of FIG. 2, a voltage control module 211) of the tunable power supply device 200 is a buck circuit which includes a comparator 211, a pulse width modulation (PWM) controller 212, a first buffer 213, a second buffer 214, a first N-type transistor MN1, a second N-type transistor MN2, an inductor L1, and a capacitor C1. The comparator 211 may be an operational amplifier (OP). The comparator 211 can compare the feedback voltage VFB with a reference voltage VREF, so as to generate a comparison voltage VCM. The reference voltage VREF may be a constant value. Specifically, the comparator 211 may have a positive input terminal for receiving the feedback voltage VFB, a negative input terminal for receiving the reference voltage VREF, and an output terminal for outputting the comparison voltage VCM. The PWM controller 212 can generate a first control signal SC1 and a second control signal SC2 according to the comparison voltage VCM, FIG. 3 is a diagram of signal waveforms of the first control signal SC1 and the second control signal SC2 according to an embodiment of the invention, where the horizontal axis represents time, and the vertical axis represents the voltage level of each signal. In the embodiment of FIG. 3, the first control signal SC1 and the second control signal SC2 are two pulse signals with complementary logic levels. The pulse widths W1 of the first control signal SC1 and the second control signal SC2 are adjusted according to the comparison voltage VCM. For example, when the feedback voltage VFB is higher than the reference voltage VREF and the comparison voltage VCM has a high logic level, the PWM controller 212 may make the pulse widths W1 of the first control signal SC1 and the second control signal SC2 become narrower; when the feedback voltage VFB is lower than the reference voltage VREF and the comparison voltage VCM has a low logic level, the PWM controller 212 may make the pulse widths W1 of the first control signal SC1 and the second control signal SC2 become wider. The aforementioned negative feedback mechanism can automatically fine-tune the output voltage VOUT to its best value, such as a target system voltage.

The first buffer 213 is configured to buffer the first control signal SC1. The second buffer 214 is configured to buffer the second control signal SC2. Each of the first N-type transistor MN1 and the second N-type transistor MN2 may be an N-type metal-oxide-semiconductor field-effect transistor (i.e., an N-type MOSFET or an NMOS transistor). The first N-type transistor MN1 has a control terminal for receiving the first control signal SC1 through the first buffer 213, a first terminal coupled to a third node N3, and a second terminal coupled to the input node NIN for receiving the input voltage VIN. The second N-type transistor MN2 has a control terminal for receiving the second control signal SC2 through the second buffer 214, a first terminal coupled to the ground voltage VSS, and a second terminal coupled to the third node N3. The inductor is coupled between the third node N3 and the first node N1. The capacitor C1 is coupled between the first node N1 and the ground voltage VSS. The first node N1 is arranged for outputting the median voltage VM, so as to indirectly fine-tune the output voltage VOUT. It should be noted that the input voltage VIN of the tunable power supply device 200 should be higher than the desired target system voltage since the voltage control module 210 is a buck circuit. Other features of the tunable power supply device 200 of FIG. 2 are similar to those of the tunable power supply device 100 of FIG. 1. Accordingly, the two embodiments can achieve similar levels of performance.

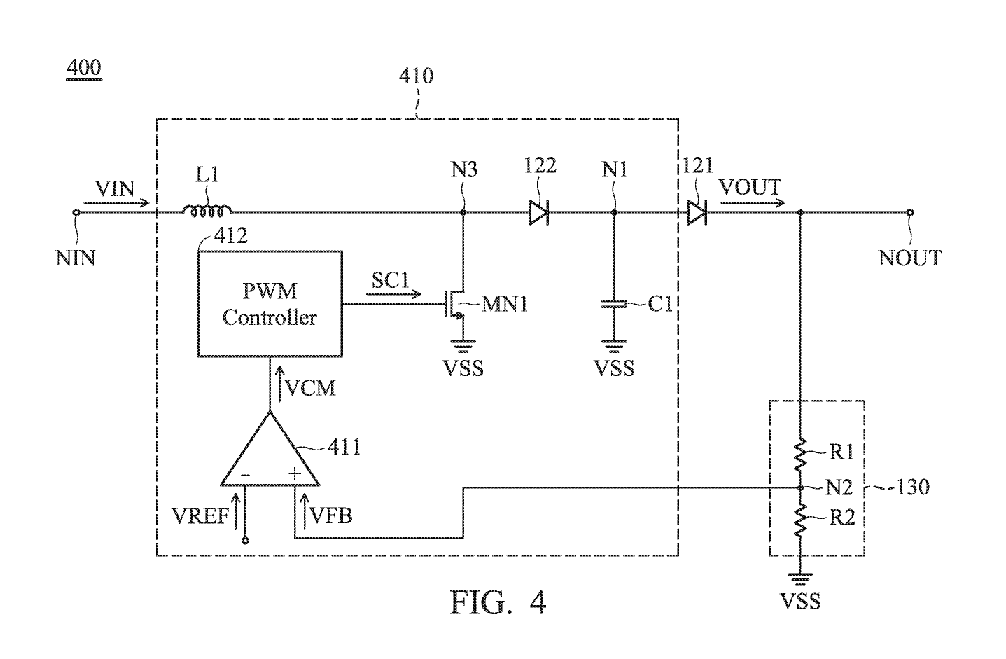

FIG. 4 is a diagram of a tunable power supply device 400 according to an embodiment of the invention. In the embodiment of FIG. 4, a voltage control module 410 of the tunable power supply device 400 is a boost circuit which includes a comparator 411, a pulse width modulation (PWM) controller 412, a first N-type transistor MN1, a second diode 122, an inductor L1, and a capacitor C1. The comparator 411 may be an operational amplifier (OP). The comparator 411 can compare the feedback voltage VFB with a reference voltage VREF, so as to generate a comparison voltage VCM. The reference voltage VREF may be a constant value. Specifically, the comparator 411 may have a positive input terminal for receiving the feedback voltage VFB, a negative input terminal for receiving the reference voltage VREF, and an output terminal for outputting the comparison voltage VCM. The PWM controller 412 can generate a first control signal SC1 according to the comparison voltage VCM (the waveform of the first control signal SC1 may be as described in the embodiment of FIG. 3). The pulse width W1 of the first control signal SC1 is adjusted according to the comparison voltage VCM. For example, when the feedback voltage VFB is higher than the reference voltage VREF and the comparison voltage VCM has a high logic level, the PWM controller 412 may make the pulse width W1 of the first control signal SC1 become narrower; when the feedback voltage VFB is lower than the reference voltage VREF and the comparison voltage VCM has a low logic level, the PWM controller 412 may make the pulse width W1 of the first control signal SC1 become wider. The aforementioned negative feedback mechanism can automatically fine-tune the output voltage VOUT to its best value, such as a target system voltage.

The inductor L1 is coupled between the input node NIN and a third node N3, and is arranged for receiving the input voltage VIN. The first N-type transistor MN1 may be an N-type metal-oxide-semiconductor field-effect transistor (i.e., an N-type MOSEET or an NMOS transistor). The first N-type transistor MN1 has a control terminal for receiving the first control signal SC1, a first terminal coupled to the ground voltage VSS, and a second terminal coupled to the third node N3. The second diode 122 has an anode coupled to the third node N3, and a cathode coupled to the first node N1. The capacitor C1 is coupled between the first node N1 and the ground voltage VSS. The first node N1 is arranged for outputting the median voltage VM, so as to indirectly fine-tune the output voltage VOUT. It should be noted that the input voltage VIN of the tunable power supply device 400 should be lower than the desired target system voltage since the voltage control module 410 is a boost circuit. Other features of the tunable power supply device 400 of FIG. 4 are similar to those of the tunable power supply device 100 of FIG. 1. Accordingly, the two embodiments can achieve similar levels of performance.

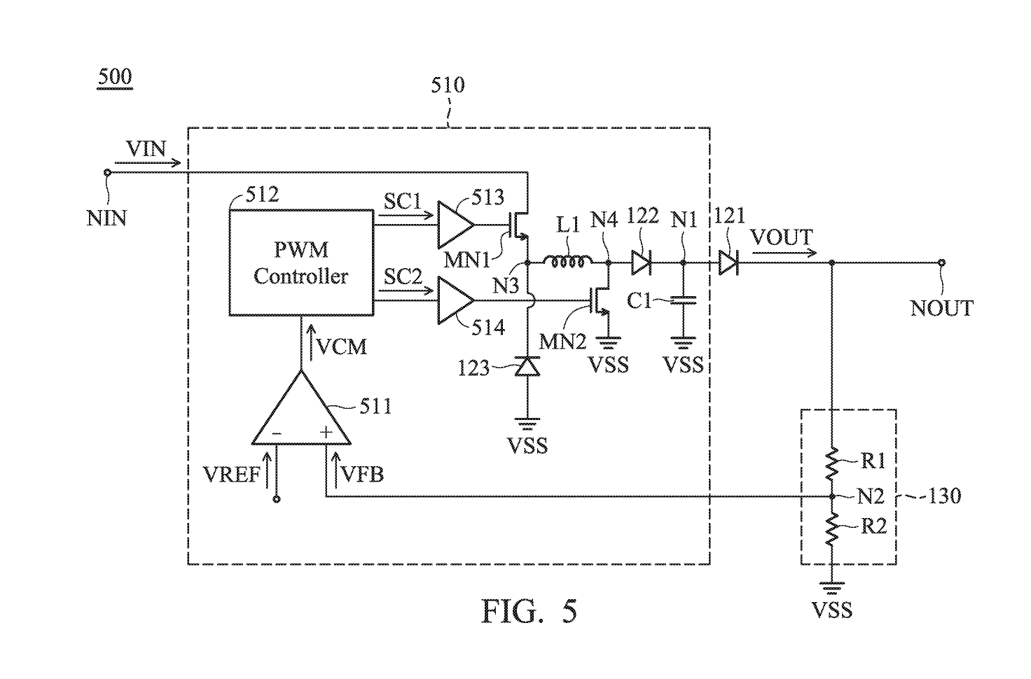

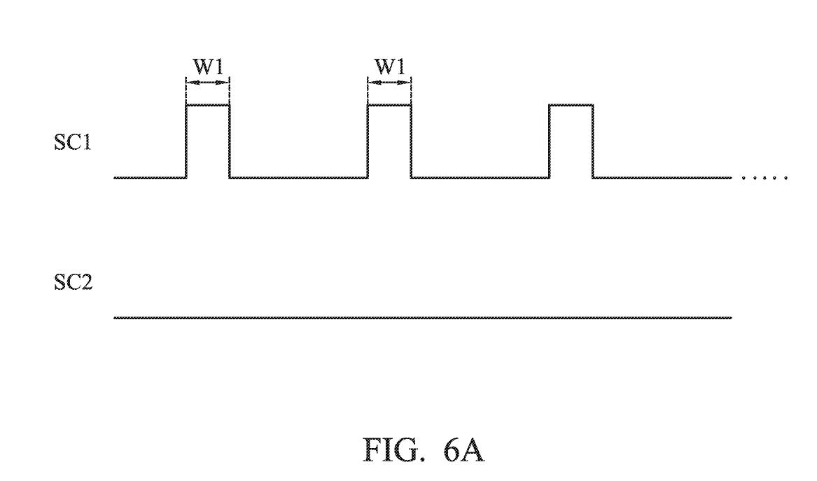

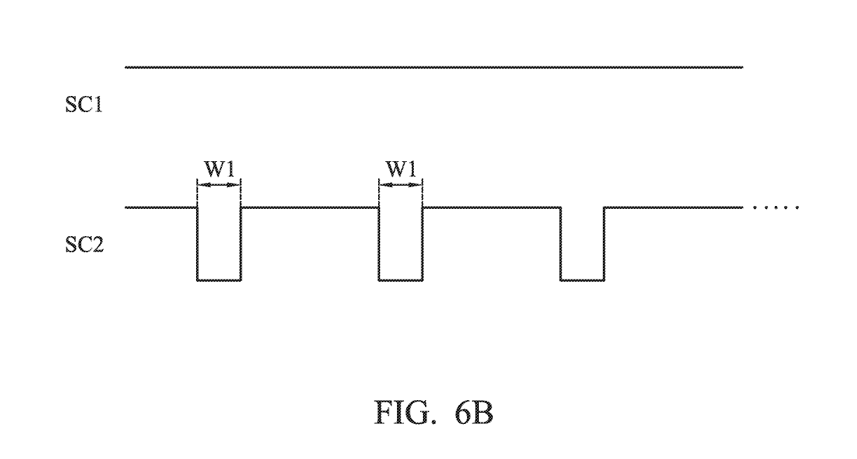

FIG. 5 is a diagram of a tunable power supply device 500 according to an embodiment of the invention. In the embodiment of FIG. 5, a voltage control module 510 of the tunable power supply device 500 is a boost-buck circuit which includes a comparator 511, a pulse width modulation (PWM) controller 512, a first buffer 513, a second buffer 514, a first N-type transistor MN1, a second N-type transistor MN2, a second diode 122, a third diode 123, an inductor L1, and a capacitor C1. The comparator 511 may be an operational amplifier (OP). The comparator 511 can compare the feedback voltage VFB with a reference voltage VREF, so as to generate a comparison voltage VCM. The reference voltage VREF may be a constant value. Specifically, the comparator 511 may have a positive input terminal for receiving the feedback voltage VFB, a negative input terminal for receiving the reference voltage VREF, and an output terminal for outputting the comparison voltage VCM. The PWM controller 512 can generate a first control signal SC1 and a second control signal SC2 according to the comparison voltage VCM. The first control signal SC1 and the second control signal SC2 are two pulse signals with complementary logic levels. The pulse widths W1 of the first control signal SC1 and the second control signal SC2 are adjusted according to the comparison voltage VCM (for the first control signal SC1, its pulse width W1 means the time length of each high-logic interval; for the second control signal SC2, its pulse width W1 means the tune length of each low-logic interval). FIG. 6A is a diagram of signal waveforms of the first control signal SC1 and the second control signal SC2 according to an embodiment of the invention, where the horizontal axis represents time, and the vertical axis represents the voltage level of each signal. FIG. 6A describes the signal waveforms relative to the voltage control module 510 used as a buck circuit. In the embodiment of FIG. 6A, when the feedback voltage VFB is higher than the reference voltage VREF and the comparison voltage VCM has a high logic level, the PWM controller 512 may make the pulse width W1 of the first control signal SC1 become narrower. At this time, the second control signal SC2 is kept unchanged at a low logic level. FIG. 6B is a diagram of signal waveforms of the first control signal SC1 and the second control signal SC2 according to an embodiment of the invention, where the horizontal axis represents time, and the vertical axis represents the voltage level of each signal. FIG. 6B describes the signal waveforms relative to the voltage control module 510 used as a boost circuit. In the embodiment of FIG. 6B, when the feedback voltage VFB is lower than the reference voltage VREF and the comparison voltage VCM has a low logic level, the PWM controller 512 may make the pulse width W1 of the second control signal SC2 become wider. At this time, the first control signal SC1 is kept unchanged at a high logic level. The aforementioned negative feedback mechanism can automatically fine-tune the output voltage VOLT to its best value, such as a target system voltage.

The first buffer 513 is configured to buffer the first control signal SC1. The second buffer 514 is configured to buffer the second control signal SC2. Each of the first N-type transistor MN1 and the second N-type transistor MN2 may be an N-type metal-oxide-semiconductor field-effect transistor (i.e., an N-type MOSFET or an NMOS transistor). The first N-type transistor MN1 has a control terminal for receiving the first control signal SC1 through the first buffer 513, a first terminal coupled to a third node N3, and a second terminal coupled to the input node NIN for receiving the input voltage YIN. The second N-type transistor MN2 has a control terminal for receiving the second control signal SC2 through the second buffer 514, a first terminal coupled to the ground voltage VSS, and a second terminal coupled to a fourth node N4. The inductor L1 is coupled between the third node N3 and the fourth node N4. The second diode 122 has an anode coupled to the fourth node N4, and a cathode coupled to the first node N1. The third diode 123 has an anode coupled to the ground voltage VSS, and a cathode coupled to the third node N3. The capacitor C1 is coupled between the first node N1 and the ground voltage VSS. The first node N1 is arranged for outputting the median voltage VM, so as to indirectly fine-tune the output voltage VOUT. It should be noted that the input voltage VIN of the tunable power supply device 500 should be higher than, equal to, or lower than the desired target system voltage since the voltage control module 510 is a boost-buck circuit. Other features of the tunable power supply device 500 of FIG. 5 are similar to those of the tunable power supply device 100 of FIG. 1. Accordingly, the two embodiments can achieve similar levels of performance.

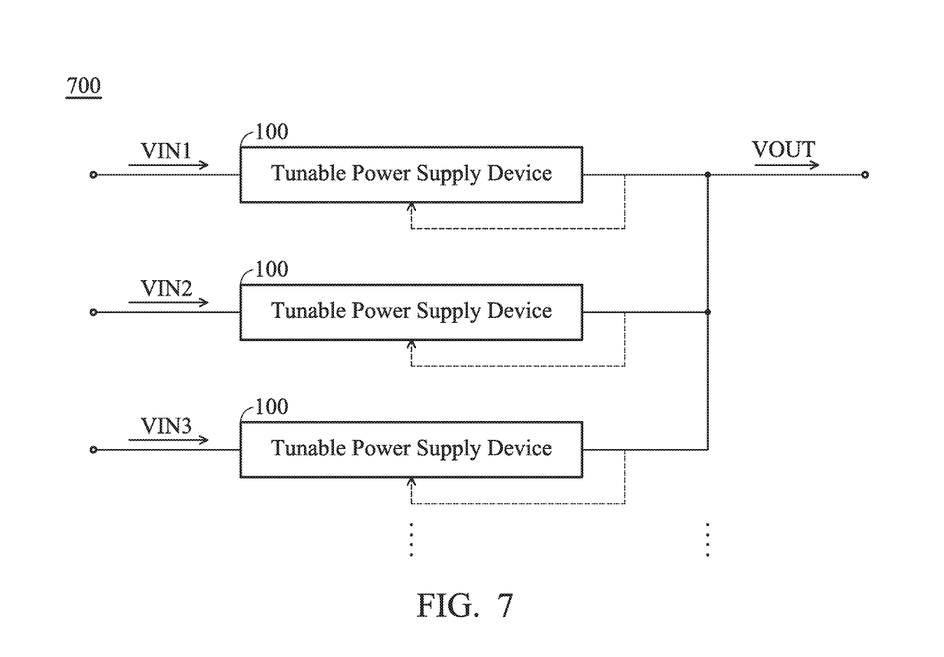

FIG. 7 is a diagram of a parallel power supply system 700 according to an embodiment of the invention. In the embodiment of FIG. 7, the parallel power supply system 700 includes a plurality of tunable power supply devices 100 for receiving a plurality of input voltages VIN1, VIN2, and VIN3. The functions and structures of these tunable power supply devices 100 may be as described in the embodiments of FIGS. 1 to 6. The tunable power supply devices 100 are coupled in parallel, so as to generate the same output voltage VOUT, such as a target system voltage. A plurality of voltage control modules of the tunable power supply devices 100 may include a boost circuit, a buck circuit, a boost-buck circuit, or a combination thereof. In other words, the parallel power supply system 700 may include one or more selected among the tunable power supply device 200 of FIG. 2 (its voltage control module is a buck circuit), the tunable power supply device 400 of FIG. 4 (its voltage control module is a boost circuit), and the tunable power supply device 500 of FIG. 5 (its voltage control module is a boost-buck circuit). The selected tunable power supply devices are combined and coupled in parallel. With such a design, even if the input voltages VIN1, VIN2, and VIN3 are different from each other, the parallel power supply system 700 can appropriately adjust them and generate the same output voltage VOUT, so as to perform high-efficiency parallel power supply to an electronic device or a mobile device. It should be noted that FIG. 7 shows three tunable power supply devices, but the invention is not limited to the above. In other embodiments, the parallel power supply system 700 may include fewer or more tunable power supply devices of the same/different types, so as to meet a variety of requirements of application.

In conclusion, compared with the conventional design, the proposed tunable power supply device and parallel power supply system of the invention have at least the advantages of (1) tuning battery sources with different voltages to generate the same output voltage, (2) using a diode at the output node to prevent an output current from flowing back, and to prevent the whole circuit from being damaged, (3) requiring no additional current detection element as the conventional design, (4) providing a parallel arrangement to enhance the efficiency of DC power supply, and (5) reducing the total manufacturing cost. Therefore, the invention is suitable for application in a variety of electronic devices or mobile devices which require DC electric supply sources.

Note that the above element parameters are not limitations of the invention. A designer can fine-tune these settings or values according to different requirements. It should be understood that the tunable power supply device and parallel power supply system of the invention are not limited to the configurations of FIGS. 1-7. The invention may include any one or more features of any one or more embodiments of FIGS. 1-7. In other words, not all of the features displayed in the figures should be implemented in the tunable power supply device and parallel power supply system of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with the true scope of the disclosed embodiments being indicated by the following claims and their equivalents.

1. A tunable power supply device with an input node and an output node, comprising:
a voltage control module, converting an input voltage at the input node into a median voltage at a first node, wherein the median voltage is determined according to a feedback voltage;
a first diode, wherein the first diode has an anode coupled to the first node, and a cathode coupled to the output node for outputting an output voltage; and
a voltage divider circuit, generating the feedback voltage according to the output voltage;
wherein the voltage control module comprises a comparator which has a positive input terminal for receiving the feedback voltage, a negative input terminal for receiving a reference voltage, and an output terminal for outputting a comparison voltage.

2. The tunable power supply device as claimed in claim 1, wherein the voltage divider circuit comprises:
a first resistor, coupled between the output node and a second node; and
a second resistor, coupled between the second node and a ground voltage, wherein the second node is arranged for outputting the feedback voltage.

3. The tunable power supply device as claimed in claim 2, wherein the voltage control module controls the median voltage such that the output voltage is equal to a target system voltage, and wherein resistances of the first resistor and the second resistor are determined according to the target system voltage.

4. The tunable power supply device as claimed in claim 1, wherein the voltage control module is a buck circuit.

5. The tunable power supply device as claimed in claim 4, wherein the buck circuit further comprises:
a pulse width modulation (PWM) controller, generating a first control signal and a second control signal, wherein pulse widths of the first control signal and the second control signal are adjusted according to the comparison voltage;
a first buffer, buffering the first control signal;
a second buffer, buffering the second control signal;
a first N-type transistor, wherein the first N-type transistor has a control terminal for receiving the first control signal through the first buffer, a first terminal coupled to a third node, and a second terminal coupled to the input node;
a second N-type transistor, wherein the second N-type transistor has a control terminal for receiving the second control signal through the second buffer, a first terminal coupled to a ground voltage, and a second terminal coupled to the third node;
an inductor, coupled between the third node and the first node; and
a capacitor, coupled between the first node and the ground voltage.

6. The tunable power supply device as claimed in claim 1, wherein the voltage control module is a boost circuit.

7. The tunable power supply device as claimed in claim 6, wherein the boost circuit further comprises:
a pulse width modulation (PWM) controller, generating a first control signal, wherein a pulse width of the first control signal is adjusted according to the comparison voltage;
an inductor, coupled between the input node and a third node;
a first N-type transistor, wherein the first N-type transistor has a control terminal for receiving the first control signal, a first terminal coupled to a ground voltage, and a second terminal coupled to the third node;
a second diode, wherein the second diode has an anode coupled to the third node, and a cathode coupled to the first node; and
a capacitor, coupled between the first node and the ground voltage.

8. The tunable power supply device as claimed in claim 1, wherein the voltage control module is a boost-buck circuit.

9. The tunable power supply device as claimed in claim 8, wherein the boost-buck circuit further comprises:
a pulse width modulation (PWM) controller, generating a first control signal and a second control signal, wherein pulse widths of the first control signal and the second control signal are adjusted according to the comparison voltage;
a first buffer, buffering the first control signal;
a second buffer, buffering the second control signal;
a first N-type transistor, wherein the first N-type transistor has a control terminal for receiving the first control signal through the first buffer, a first terminal coupled to a third node, and a second terminal coupled to the input node;
a second N-type transistor, wherein the second N-type transistor has a control terminal for receiving the second control signal through the second buffer, a first terminal coupled to a ground voltage, and a second terminal coupled to a fourth node;
an inductor, coupled between the third node and the fourth node;
a second diode, wherein the second diode has an anode coupled to the fourth node, and a cathode coupled to the first node;
a third diode, wherein the third diode has an anode coupled to the ground voltage, and a cathode coupled to the third node; and
a capacitor, coupled between the first node and the ground voltage.

10. A parallel power supply system, comprising:
a plurality of tunable power supply devices, each as claimed in claim 1, wherein the plurality of tunable power supply devices are coupled in parallel, so as to generate the same output voltage.

11. The parallel power supply system as claimed in claim 10, wherein the voltage control modules of the plurality of tunable power supply devices comprise a boost circuit, a buck circuit, a boost-buck circuit, or a combination thereof.
